(19) United States
(12) Patent Application Publication
(10) Pub. No.: US 2012/0142844 A1
(43) Pub. Date: Jun. 7, 2012

(54) Aqueous hybrid binder for jointing mortars

(75) Inventors: Frank Sandmeyer, Burgkirchen (DE); Dominik Auer, Altotting (DE)

(73) Assignee: Wacker Chemie AG, Munich (DE)

(21) Appl. No.: 13/302,681

(22) Filed: Nov. 22, 2011

(30) Foreign Application Priority Data
Nov. 26, 2010 (DE) 10 2010 062 054.8

(51) Int. Cl. C04B 26/06; B82Y 30/00

(52) U.S. Cl. 524/506; 977/773

(57) ABSTRACT

A process for preparing jointing mortar includes using copolymers of ethylenically unsaturated monomers and of ethylenically functionalized nanoparticles in the form of their aqueous polymer dispersions or water-redispersible polymer powders. The copolymers are obtained by means of free-radically initiated polymerization in aqueous medium, and optionally subsequent drying of the resultant polymer dispersion, of
A) one or more unsaturated monomers in the presence of
B) at least one particle P having an average diameter of ≦1000 nm and functionalized with ethylenically unsaturated, free-radically polymerizable groups.

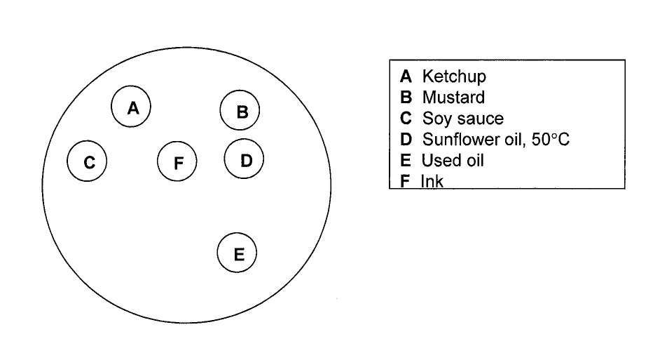

### CROSS REFERENCE TO RELATED APPLICATIONS

This application claims priority of German patent application number 10 2010 062 054.8, filed 26 Nov. 2010, the entirety of which application is incorporated herein by reference.

### FIELD OF THE INVENTION

The invention relates to the use of copolymers of ethylenically unsaturated monomers and of ethylenically functionalized nanoparticles, in the form of their aqueous dispersions of water-redispersible powders.

### BACKGROUND OF THE INVENTION

The use of planar or nonplanar components made from ceramic, stone, concrete or other materials to clad surfaces in the construction and building segments, these components being generally known as tiles, is long-established prior art. These tiles are always mounted so as to leave gaps between them, which are filled in subsequently. These interstices are filled in using jointing mortars grouts. These jointing mortars are frequently cementitious mixtures which are combined with water and introduced into the tile interstices. Apart from cement, synthetic resins are also employed, such as epoxy resins, and may have technical advantages over cementitious systems. Cementitious systems are penetrable and easily wetted, and therefore sensitive to soiling. Attempts are made to counter this circumstance by the addition of additives such as silicones, for example, which raise the hydrophobicity of the jointing materials, or by admixing polymeric binders, such as acrylate polymers (see, e.g., U.S. Pat. No. 4,472,540) or epoxy resins, for example, the latter in particular having very good chemical resistance and soiling resistance and mechanical properties. Disadvantages of the epoxy resin systems, however, are that they include ingredients harmful to health, and are very difficult to apply. U.S. Pat. No. 4,833,178, for example, describes an epoxy resin-bound jointing mortar system that uses a combination of a hardener and an epoxy resin, which are mixed with one another immediately prior to application. Jointing mortars of this kind harden relatively rapidly, this also being the particular feature of the invention according to U.S. Pat. No. 4,833,178, and form an adhered assembly with the tiles that is very firm and virtually impossible to part. This means that contamination of the tiles resulting from the application of the jointing mortar must be removed immediately, since its subsequent removal is virtually impossible without damaging the tiles. Moreover, such ready-to-use mixtures have to be used up all at once, since they are no longer storable. Where hardener and resin are mixed together, the storage life corresponds to the pot life, which does not exceed a few hours.

Consequently, epoxy resin-bound jointing mortars can be employed per se only by professional users.

US 2005/0197444 describes jointing mortars which comprise air-drying acrylate polymers as binders, along with a polymeric component which reduces the soiling tendency. This component may be a siloxane, a siliconate or a silane, such as a fluoropolymer. The soil-repelling components, as is apparent from the recitation, are components having a low surface tension. They readily undergo separation toward the surface, where they are active with great efficiency against soiling. However, they are also concentrated only at the surface. If the surface is mechanically damaged in the course of its service life, or the upper layers are removed by abrasion or other influences, the effect is lost and, ultimately, the disadvantages that occur are the same as those for jointing mortars not equipped with substances of these kinds. Since silicones or fluoropolymers, moreover, are very incompatible components, which are not easily mixed with other polymers, it is impossible to disperse them homogeneously throughout the jointing mortar matrix. Such uniform distribution can be achieved only by chemically bonding the active antisoiling components to the polymer matrix and thereby preventing separation to the surface. The homogeneous distribution of silicones, for example, in a polymer matrix which is inherently incompatible with them is possible only when the silicones are present in the polymer at the time the latter is actually formed, in a phase in which the incompatibility has not yet developed. Furthermore, it is necessary to use a suitable polymerization technology, which ensures that the chemical attachment of the silicone to the polymer matrix does actually occur, and that no silicone domains detached from the polymer matrix are formed. These silicone domains would indeed be present, in some circumstances in finely distributed form, in the polymer matrix as well; however, owing to the incompatibilities between the silicone and the surrounding polymer matrix, there are repulsion effects in the marginal region, which lead to microporosity. This results in the formation of channels for the inward penetration of soiling substances or water, adversely affecting not only the functional capacity but also the esthetic impression of a joint.

It is the object of the present invention to improve the prior art, and more particularly to provide appropriate polymers used in jointing mortars that comprise such dirt-repelling components as an integral constituent which is uniformly distributed in the polymer matrix, with the soiling-repelling substances being dispersed homogeneously in the jointing mortar, when this polymer is used in the jointing mortar, without the disadvantageous repulsion effects.

Polymer dispersions which comprise particles having dimensions in the nanometer range, i.e., particles measuring less than 100 nm in at least one dimension, have a host of superior and innovative properties relative to composites with a few finely divided particles (in the micrometer range, for instance). These properties include, for example, light scattering, adsorption and absorption, antibacterial properties, or superior scratch resistances and tensile strengths. These “nano-effects” correlate directly to the size of the particles, and are lost if the particles exceed certain dimensions.

Furthermore, the desired effects are particularly pronounced only when success is achieved in dispersing the particles very homogeneously in the polymer matrix and, if possible, attaching them chemically, in order to prevent entrainment or agglomeration phenomena and hence the loss of these special properties.

One possibility for the chemical attachment of nanoscale metal oxides to polymeric matrices is described in DE 10212121 A1, for example, for nano-zinc oxide polymer dispersions. Zinc oxide particles here are dispersed in a halogen-containing medium, the dispersion is introduced into an aqueous solution of inorganic polymers containing hydroxyl groups, such as of hydrolyzed polyalkyl(alkoxy)siloxanes, for example, and then the halogen-containing constituents are removed by distillation. Chemical attachment to the polymer is therefore via the formation of a Zn—O—Si—O—C bridge and is therefore very unstable in the face of acidic or alkaline cleavage.

Where the particles are silicone resins, it is known that they can be used for the chemical modification of organic polymers, or as binders in coatings, in order to increase the resistance of the coatings with respect, for example, to effects of weathering, chemical attack, and thermal load. Commercially available products are, for example, silicone polyesters, hybrid systems comprising silicone resins and organic polymers, of the kind used for producing coil coatings on metal. These products are prepared preferably by chemical reaction and bond formation between the silicone resin and the organic polymer. Chemical attachment of the silicone resins to the organic polymer in this case generally involves the formation of a Si—O—C bridge between the two, customarily in a solvent process. For aqueous media, the literature is aware of various products comprising combinations of organic polymers with silicone resins or resinous oligomeric silicone structures, and processes for their preparation:

EP 1256611 A2 describes an aqueous dispersion obtained from a mixture and emulsion of non-free-radically polymerizable alkoxysilanes or their hydrolysis and condensation products with free-radically polymerizable monomers. The silanes or the products derived from them are hydrolyzed and condensed, while the organic monomers are free-radically polymerized. The silanes used in this case are alkyl- or arylalkoxysilanes, and there may be up to three alkoxy groups attached to silicon. From these it is possible to gain access, by hydrolysis and condensation, to resins or resinlike oligomers inter alia.

EP 1197502 A2 teaches the preparation of an aqueous resin emulsion by free-radical polymerization of ethylenically unsaturated monomers in the presence of hydrolyzable and condensable mono-, di- or trialkoxyalkyl- or -aryl-silanes, which are not free-radically polymerizable.

EP 943634 A1 describes aqueous lattices for use as coating materials, prepared by copolymerization of ethylenically unsaturated monomers in the presence of a silicone resin containing silanol groups. In this case, interpenetrating networks (IPN) are formed between the polymer chains and the polysiloxane chains.

The silicone resin emulsion polymers obtainable with the processes stated, and also the otherwise well-known physical mixtures of silicone resin emulsions and organic polymer dispersions, for use in the segment of silicone resin masonry paints for example, are distinguished by the fact that the silicone resin and the organic polymer are present exclusively or predominantly in the form of physical blends. Chemical bonds between the silicone fraction and the organic fraction are built up more on a chance basis, and comprise Si—O—C bonds, which are susceptible to hydrolysis. The Si—O—C bonding in this case is always in competition with the formation of Si—O—Si bridges through condensation of the silanol groups with one another.

The condensation reactions of the silane units or of their hydrolyzed and partly condensed oligomers under the hydrolytic conditions of an emulsion polymerization cannot be adequately controlled. It is known that especially alkoxysilanes having short, oxygen-attached alkyl radicals have a pronounced tendency under hydrolytic conditions to undergo additive condensation to the point of becoming solid particles. These particles tend toward formation of precipitates and domains, and hence toward separation. The greater the number of alkoxy groups attached to the silicon, the more pronounced this tendency. In a coating material application, this may have adverse consequences in the form of bittiness. As a result of separation, the products may suffer reductions in their shelf life and serviceability.

A more defined attachment of the silicone unit to the organic polymer via the formation of C—C bonds can be accomplished by copolymerizing organic monomers with double-bond-functionalized silicones. For example, EP 1308468 A1 describes hydrophobically modified copolymers which are obtained by copolymerizing organic monomers in emulsion with linear silicones having up to two polymerizable groups. A similar approach is pursued by EP 352339 A1, in which vinyl-terminated, linear polydimethylsiloxanes are copolymerized with (meth)acrylate monomers. EP 771826 A2 describes the emulsion polymerization of (meth)acrylic esters and vinylaromatics, with difunctional silicones containing acrylic groups or vinyl groups being added for crosslinking. EP 635 526 A1 describes functional graft polymers based on organopolysiloxanes, obtained by grafting polyorganosiloxanes with ethylenically unsaturated monomers containing hydrogen or functional groups, and also containing ethylenically unsaturated groups.

The preparation of particle-containing organocopolymer dispersions is subject matter of EP 1216262 B1 and EP 1235869 B1, an aqueous dispersion of inorganic particulate solids and organopolymer being prepared using inorganic particulate solids characterized by a defined degree of dispersion and a defined electrophoretic mobility, and polymerizing ethylenically unsaturated monomers in the presence of said solids. EP 505230 A1 describes the encapsulation of silicon oxide particles with organopolymer, where first the silicon dioxide particles are functionalized with ethylenically unsaturated alkoxysilane compounds and then ethylenically unsaturated monomers are polymerized in aqueous dispersion in the presence of these functionalized particles.

### SUMMARY OF THE INVENTION

The attachment of polymer to nanoparticle has to date been unsatisfactory, because no stable C—C bond has been obtained. The object, therefore, was to provide particle-containing dispersions in which there is stable attachment of the polymer component to the nanoparticle, in a simple way, and to show the usefulness of such dispersions as binders for jointing mortars.

The covalent chemical fixing of the particles to the organic matrix via C—C bonds in an aqueous medium has now been achieved by functionalizing the particles to be fixed, using a special class of ethylenically unsaturated silanes, characterized only by a C atom between silane function and organic function (“alpha-silanes”). In contrast to reagents used previously, the silanes have a high reactivity in respect of functionalization, and, surprisingly, are stable under the polymerization conditions at the same time. It has also been found that the polymerization conditions, in contrast to the prior art, are selected such that effective copolymerization of the hydrophobic particles with organic monomers is carried out in the aqueous medium with very substantial retention of the particle identity at the same time.

### BRIEF DESCRIPTION OF THE DRAWING

The drawing is a schematic representation of a stain placement pattern used during evaluation of soilability of a treated substrate.

### DETAILED DESCRIPTION OF THE INVENTION

The invention provides a process for preparing jointing mortar, which comprises using copolymers of ethylenically unsaturated monomers and of ethylenically functionalized nanoparticles in the form of their aqueous polymer dispersions or water-redispersible polymer powders, obtainable by means of free-radically initiated polymerization in aqueous medium, and optionally subsequent drying of the resultant polymer dispersion, of
A) one or more monomers from the group encompassing vinyl esters, (meth)acrylic esters, vinylaromatics, olefins, 1,3-dienes, vinyl ethers and vinyl halides, and optionally further monomers copolymerizable therewith, in the presence of
B) at least one particle P having an average diameter of ≦1000 nm and functionalized with ethylenically unsaturated, free-radically polymerizable groups, where
B1) one or more particles from the group of the metal oxides and semimetal oxides are used as particles P, and/or
B2) silicone resins are used as particles P, said resins being composed of repeating units of the general formula [R⁴_{(p+z)}SiO_{(4-p-z)/2}] (II) where R⁴ is identical or different at each occurrence and denotes hydrogen, hydroxyl, and also alkyl, cycloalkyl, aryl, alkoxy or aryloxy radicals, having in each case up to 18 C atoms, and being optionally substituted, with p+z being 0, 1 or 3 for at least 20 mol % of the respective silicone resin,

and where B1) and B2) are each functionalized with one or more α-organosilanes of the general formula (R¹O)₃₋ₙ(R²)ₙSi—(CR³₂)—X (1), where R¹ is hydrogen, an alkyl radical having 1 to 6 carbon atoms or an aryl radical, R² and R³ each independently of one another are hydrogen, an alkyl radical having 1 to 12 carbon atoms or an aryl radical, n may be 0, 1 or 2, and X is a radical having 2 to 20 hydrocarbon atoms and an ethylenically unsaturated group.

The invention further provides a jointing mortar which comprises copolymers of ethylenically unsaturated monomers and of ethylenically functionalized nanoparticles, in the form of their aqueous polymer dispersions or water-redispersible polymer powders, obtainable by means of free-radically initiated polymerization in aqueous medium, and optionally subsequent drying of the resultant polymer dispersion, of
A) one or more monomers from the group encompassing vinyl esters, (meth)acrylic esters, vinylaromatics, olefins, 1,3-dienes, vinyl ethers and vinyl halides, and optionally further monomers copolymerizable therewith, in the presence of
B) at least one particle P having an average diameter of ≦1000 nm and functionalized with ethylenically unsaturated, free-radically polymerizable groups, where
B1) one or more particles from the group of the metal oxides and semimetal oxides are used as particles P, and/or
B2) silicone resins are used as particles P, said resins being composed of repeating units of the general formula [R⁴_{(p+z)}SiO_{(4-p-z)/2}] (II) where R⁴ is identical or different at each occurrence and denotes hydrogen, hydroxyl, and also alkyl, cycloalkyl, aryl, alkoxy or aryloxy radicals, having in each case up to 18 C atoms, and being optionally substituted, with p+z being 0, 1 or 3 for at least 20 mol % of the respective silicone resin,

and where B1) and B2) are each functionalized with one or more α-organosilanes of the general formula (R¹O)₃₋ₙ(R²)ₙSi—(CR³₂)—X (1), where R¹ is hydrogen, an alkyl radical having 1 to 6 carbon atoms or an aryl radical, R² and R³ each independently of one another are hydrogen, an alkyl radical having 1 to 12 carbon atoms or an aryl radical, n may be 0, 1 or 2, and X is a radical having 2 to 20 hydrocarbon atoms and an ethylenically unsaturated group.

Suitable vinyl esters are those of carboxylic acids having 1 to 15 C atoms. Preference is given to vinyl acetate, vinyl propionate, vinyl butyrate, vinyl 2-ethylhexanoate, vinyl laurate, 1-methylvinyl acetate, vinyl pivalate, and vinyl esters of α-branched monocarboxylic acids having 9 to 11 C atoms, as for example VeoVa9® or VeoVa10® (tradenames of the company Resolution). Particular preference is given to vinyl acetate.

Suitable monomers from the group of acrylic esters or methacrylic esters are preferably esters of unbranched or branched alcohols having 1 to 15 C atoms, more preferably dodecanol, octanol, isooctanol, hexanol, butanol, isobutanol, propanol, isopropanol, ethanol, and methanol, very preferably hexanol, butanol, propanol, isopropanol, ethanol, and methanol. Preferred methacrylic esters or acrylic esters are methyl acrylate, methyl methacrylate, ethyl acrylate, ethyl methacrylate, propyl acrylate, propyl methacrylate, n-butyl acrylate, n-butyl meth-acrylate, isobutyl acrylate, isobutyl methacrylate, tert-butyl-acrylate, tert-butyl methacrylate, 2-ethylhexyl acrylate, and norbornyl acrylate. Particularly preferred are methyl acrylate, methyl methacrylate, n-butyl acrylate, isobutyl acrylate, tert-butyl acrylate, 2-ethylhexyl acrylate, and norbornyl acrylate.

Preferred vinylaromatics are styrene, alpha-methylstyrene, the isomeric vinyltoluenes and vinylxylenes, and also divinylbenzenes. Particularly preferred is styrene.

The vinyl halogen compounds include preferably vinyl chloride, vinylidene chloride, additionally tetrafluoroethylene, difluoroethylene, hexylperfluoroethylene, 3,3,3-trifluoropropene, perfluoropropyl vinyl ether, hexafluoropropylene, chlorotrifluoroethylene, and vinyl fluoride. Particularly preferred is vinyl chloride.

One preferred vinyl ether is methyl vinyl ether, for example.

The preferred olefins are ethene, propene, 1-alkylethenes, and polyunsaturated alkenes, and the preferred dienes are 1,3-butadiene and isoprene. Particularly preferred are ethene and 1,3-butadiene.

Optionally it is possible also for 0.1% to 5% by weight, based on the total weight of the monomers A), of auxiliary monomers to be copolymerized. It is preferred to use 0.5% to 2.5% by weight of auxiliary monomers. Examples of auxiliary monomers are ethylenically unsaturated monocarboxylic and dicarboxylic acids, preferably acrylic acid, methacrylic acid, fumaric acid, and maleic acid; ethylenically unsaturated carboxamides and carbonitriles, preferably acrylamide and acrylonitrile; mono-esters and diesters of fumaric acid and maleic acid such as the diethyl and diisopropyl esters, and also maleic anhydride, ethylenically unsaturated sulfonic acids and their salts, preferably vinylsulfonic acid, 2-acrylamido-2-methylpropanesulfonic acid. Further examples are precrosslinking comonomers such as polyethylenically unsaturated comonomers, examples being divinyl adipate, diallyl maleate, allyl methacrylate or triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide, N-methylolallylcarbamate, alkyl ethers such as the isobutoxy ether or esters of N-methylolacrylamide, of N-methylolmethacrylamide, and of N-methylolallylcarbamate. Also suitable are epoxide-functional comonomers such as glycidyl methacrylate and glycidyl acrylate. Mention may also be made of monomers with hydroxyl or CO groups, examples being methacrylic and acrylic hydroxyalkyl esters such as hydroxyethyl, hydroxypropyl or hydroxybutyl acrylate or methacrylate, and also compounds such as diacetonacrylamide and acetylacetoxyethyl acrylate or meth-acrylate.

Used with particular preference as comonomers A) are one or more monomers from the group vinyl acetate, vinyl esters of α-branched monocarboxylic acids having 9 to 11 C atoms, vinyl chloride, ethylene, methyl acrylate, methyl methacrylate, ethyl acrylate, ethyl methacrylate, propyl acrylate, propyl methacrylate, n-butyl acrylate, n-butyl methacrylate, 2-ethylhexyl acrylate, styrene, 1,3-butadiene. Used with particular preference as comonomers A) are also mixtures of vinyl acetate and ethylene; mixtures of vinyl acetate, ethylene, and a vinyl ester of α-branched monocarboxylic acids having 9 to 11 C atoms; mixtures of n-butyl acrylate and 2-ethylhexyl acrylate and/or methyl methacrylate; mixtures of styrene and one or more monomers from the group methyl acrylate, ethyl acrylate, propyl acrylate, n-butyl acrylate, 2-ethylhexyl acrylate; mixtures of vinyl acetate and one or more monomers from the group methyl acrylate, ethyl acrylate, propyl acrylate, n-butyl acrylate, 2-ethylhexyl acrylate, and optionally ethylene; mixtures of 1,3-butadiene and styrene and/or methyl methacrylate; the stated mixtures may optionally further comprise one or more of the aforementioned auxiliary monomers.

The monomer selection and the selection of the weight fractions of the comonomers are made so as to result generally, preferably, in a glass transition temperature Tg of ≦60° C., preferably −50° C. to +60° C. The glass transition temperature Tg of the polymers can be determined in a known way by means of differential scanning calorimetry (DSC). The Tg may also be calculated approximately in advance by means of the Fox equation. According to Fox T. G., Bull. Am. Physics Soc. 1, 3, page 123 (1956), the following holds: 1/Tg=x1/Tg1+x2/Tg2+ . . . +xn/Tgn, where xn stands for the mass fraction (% by weight/100) of the monomer n, and Tgn is the glass transition temperature, in kelvins, of the homopolymer of the monomer n. Tg values for homopolymers are listed in Polymer Handbook 2nd Edition, J. Wiley & Sons, New York (1975).

The fraction of the comonomers A is preferably ≧50% by weight, more preferably 70% to 90% by weight, based in each case on the total weight of A) and functionalized B).

Suitable particles P from the group B1) are silicon oxides and metal oxides. Among the metal oxides, the oxides of the metals aluminum, titanium, zirconium, tantalum, tungsten, hafnium, zinc and tin are preferred. Among the silicon oxides, colloidal silica, fumed silica, precipitated silica, and silica sols are particularly preferred. Among the metal oxides, aluminum oxides such as corundum, aluminum mixed oxides with other metals and/or silicon, titanium oxides, zirconium oxides, and iron oxides are particularly preferred.

Preferred particles P from the group of the silicone resins are those composed to an extent of at least 30 mol % of Q units, in other words those for which p+z in the general repeating formula [R⁴_{(p+z)}SiO_{(4-p-z)/2}] (II) has the definition 0. Particularly preferred silicone resins are those composed only of M and Q units—that is, those for which p+z in the general formula [R⁴_{(p+z)}SiO_{(4-p-z)/2}] (II) has only the definition 0 and 3, and those composed only of M, Q, and D units, in other words those for which p+z in the general formula [R⁴_{(p+z)}SiO_{(4-p-z)/2}] (II) has only the definition 0, 2, and 3. If the radicals R⁴ are substituted, they may additionally contain one or more identical or different heteroatoms selected from O, S, Si, Cl, F, Br, P or N atoms. Also suitable, furthermore, are those silicone resins which consist of any desired combination of M units (R₃SiO—), D units (—OSiR₂O—), T units (RSiO₃³⁻) and Q units (SiO₄⁴⁻, with the proviso that there are always T and/or Q units present and that their fraction, as a proportion of the units which make up the silicone resin, is in total at least 20 mol % and, on initial introduction in each case of only one of these units, its fraction is in each case at least 20 mol %.

Most-preferred silicone resins B2) are those which are composed substantially only of M, D, and Q units, where the molar ratio of M/Q units ranges from 30/70 to 60/40; particularly preferred resins are those having an M/Q ratio of 35/65 to 45/55.

Additionally most-preferred resins are those composed of D and T units but predominantly of T units, more particularly those composed of >80 mol % of T units, and especially those composed of virtually 100 mol % of T units.

The particles P preferably possess an average diameter of 1 to 1000 nm, more preferably 1 to 100 nm, the particle size being determined by transmission electron microscopy of the resultant dispersions or of the films obtainable from the dispersions.

By α-organosilanes are meant those silanes in which the alkoxy-, aryloxy- or OH-substituted silicon atom is connected directly via a methylene bridge to an unsaturated hydrocarbon radical which has one or more ethylenically unsaturated carbon bonds, it being possible for the hydrogen radicals of the methylene bridge to be replaced by alkyl and/or aryl radicals as well, and a C═C double bond is positioned α to the Si atom.

Suitable α-organosilanes of the formula (R¹O)₃₋ₙ(R²)ₙSi—(CR³₂)—X (I) are also those in which the carbon chain of the radicals R¹, R², and R³ is interrupted by nonadjacent oxygen, sulfur or NR⁴ groups. Preferred radicals R¹ and R² are unsubstituted alkyl groups having 1 to 6 C atoms, and a preferred radical R³ is hydrogen. The radical X may be linear, branched or cyclic. Besides the double bond, there may also be further functional groups present, which are generally inert with respect to an olefinic polymerization, examples being halogen, carboxyl, sulfinato, sulfonato, amino, azido, nitro, epoxy, alcohol, ether, ester, thioether, and thioester groups and also aromatic isocyclic and heterocyclic groups. Preferred examples of X are monounsaturated C₂ to C₁₀ radicals; most preferred as radical X are the acryloyl and methacryloyl radicals.

The fraction of the functionalized particles P is preferably 0.50 to 50% by weight, preferably 1% to 30% by weight, more preferably 10% to 20% by weight, based in each case on the total weight of component A) and of the functionalized component B).

The polymer dispersions and polymer powders used in accordance with the invention may further comprise, in addition, up to 30% by weight, based on the total weight of components A) and B), of at least one silane of the general formula (R⁵)₄₋ₘ—Si—(OR⁶)ₘ
(III), where m is a number 1, 2, 3 or 4, R⁵ is an organofunctional radical selected from the group alkoxy radical and aryloxy radical, having in each case 1 to 12 C atoms, phosphonic monoester radical, phosphonic diester radical, phosphonic acid radical, methacryloyloxy radical, acryloyloxy radical, vinyl radical, mercapto radical, isocyanato radical, it being possible for the isocyanato radical optionally to be reaction-blocked for protection from chemical reactions, hydroxyl radical, hydroxyalkyl radical, vinyl radical, epoxy radical, glycidyloxy radical, morpholino radical, piperazino radical, a primary, secondary or tertiary amino radical having one or more nitrogen atoms, it being possible for the nitrogen atoms to be substituted by hydrogen or by monovalent aromatic, aliphatic or cycloaliphatic hydrocarbon radicals, carboxylic acid radical, carboxylic anhydride radical, aldehyde radical, urethane radical, urea radical, it being possible for the radical R⁵ to be attached directly to the silicon atom or to be separated therefrom by a carbon chain of 1 to 6 C atoms, and R⁶ being a monovalent linear or branched aliphatic or cycloaliphatic hydrocarbon radical or a monovalent aromatic hydrocarbon radical having in each case 1 to 12 C atoms, or a radical —C(═O)—R⁷, where R⁷ is a monovalent linear or branched aliphatic or a cycloaliphatic hydrocarbon radical having in each case 1 to 12 C atoms or a monovalent aromatic hydrocarbon radical. The selected silane or, where appropriate, the selected silanes may be present in nonhydrolyzed form, in hydrolyzed form or in hydrolyzed and partly condensed or hydrolyzed and condensed form, or in a mixture of these forms.

Furthermore, in the case of miniemulsion polymerization, there may optionally also be hydrophobic additives present in amounts of up to 3% by weight (referred to as “co-surfactants” or hydrophobes”), based on the total weight of component A) and of the functionalized component B). In the present case, silicone particles may often take on the function of the “co-surfactant”. Other examples of co-surfactants are hexadecane, cetyl alcohol, oligomeric cyclosiloxanes, such as octamethylcyclotetrasiloxane, for example, but also vegetable oils such as rapeseed oil, sunflower oil or olive oil. Additionally suitable are organic or inorganic polymers having a number-average molecular weight of <10000.

Hydrophobes preferred in accordance with the invention are the silicone particles to be polymerized themselves, and also D3, D4, and D5 rings, and hexadecane. Particular preference is given to hexadecane and to the silicone particles that are to be polymerized.

The copolymers are prepared in a heterophase process in accordance with the known techniques of suspension, emulsion or miniemulsion polymerization (cf., e.g., Peter A. Lovell, M. S. El-Aasser, “Emulsion Polymerization and Emulsion Polymers” 1997, John Wiley and Sons, Chichester). In one particularly preferred form, the reaction is carried out in accordance with the methodology of miniemulsion polymerization. Miniemulsion polymerizations differ in certain key respects, making them particularly suitable for the copolymerization of water-insoluble comonomers, from other heterophase polymerizations (cf., e.g., K. Landfester, “Polyreactions in Miniemulsions”, Macromol. Rapid Commun. 2001, 22, 896-936, and M. S. El-Aasser, E. D. Sudol, “Miniemulsions: Overview of Research and Applications” 2004, JCT Research, 1, 20-31).

The reaction temperatures are preferably from 0° C. to 100° C., more preferably from 5° C. to 80° C., very preferably from 30° C. to 70° C.

The pH of the dispersion medium is between 2 and 9, preferably between 4 and 8, in one particularly preferred embodiment it is between 6.5 and 7.5. The pH can be adjusted before the reaction begins, by means of hydrochloric acid or sodium hydroxide solution. The polymerization can be carried out batchwise or continuously, with the introduction of all or certain constituents of the reaction mixture in the initial charge, with individual constituents of the reaction mixture being included in part in the initial charge and in part metered in subsequently, or by the metering method without an initial charge. All metered feeds take place preferably at the rate at which the component in question is consumed.

The polymerization is initiated by means of the usual water-soluble initiators or redox initiator combinations. Examples of initiators are the sodium, potassium, and ammonium salts of peroxodisulfuric acid, hydrogen peroxide, tert-butyl peroxide, tert-butyl hydroperoxide, potassium peroxodiphosphate, tert-butyl peroxopivalate, cumene hydroperoxide, isopropylbenzene monohydroperoxide, and azobisisobutyronitrile, preferably hydrogen peroxide, tert-butyl peroxide, tert-butyl hydroperoxide, tert-butyl peroxopivalate, cumene hydroperoxide, isopropylbenzene monohydroperoxide, and azobisisobutyronitrile, more preferably tert-butyl hydroperoxide and cumene hydroperoxide. The stated initiators are used preferably in amounts of 0.01% to 4.0% by weight, based on the total weight of the monomers. As redox initiator combinations, the initiators specified above are used in conjunction with a reducing agent. Suitable reducing agents are sulfites and bisulfites of monovalent cations, sodium sulfite for example, the derivatives of sulfoxylic acid such as zinc or alkali metal formaldehyde-sulfoxylates, as for example sodium hydroxymethanesulfinate, and ascorbic acid, preferably sodium hydroxymethanesulfinate, sodium sulfite, sodium hydroxymethanesulfinate, and ascorbic acid, more preferably sodium hydroxymethanesulfinate. The amount of reducing agent is preferably 0.15% to 3% by weight of the monomer amount used. In addition it is possible to introduce small amounts of a metal compound which is soluble in the polymerization medium and whose metal component is redox-active under the polymerization conditions, based, for example, on iron or on vanadium. One particularly preferred initiator system comprising the components identified above is the tert-butyl hydroperoxide/sodium hydroxymethanesulfinate/Fe (EDTA)^{2+/3+} system.

In the case of the reaction regime according to the miniemulsion polymerization methodology it is also possible to use predominantly oil-soluble initiators, for instance, preferably cumene hydroperoxide, isopropylbenzene monohydroperoxide, dibenzoyl peroxide or azobisisobutyronitrile. Preferred initiators for miniemulsion polymerizations are potassium persulfate, ammonium persulfate, azobisisobutyronitrile, and dibenzoyl peroxide.

The dimensions of the particle domains within the copolymer after copolymerization has taken place are situated preferably in the range from 1 nm to 1000 nm, preferably from 1 nm to 500 nm, and very preferably from 1 nm to 200 nm. The dimensions may be determined, for example, by scanning electron microscopy or transmission electron microscopy on the polymer dispersions or on the polymer films obtained from them.

For the preparation of water-redispersible polymer powders, the aqueous dispersions of the copolymers of the invention are dried in a manner known to the skilled person, preferably by the spray drying process.

In comparison to systems which crosslink only through formation of M-O-M (M=metal), Si—O—Si, or M-O—Si bonds, the particle-containing dispersions and redispersible powders of the invention additionally have, by virtue of the C—C bonding, an increased environmental resistance and chemical resistance, with respect, for example, to a strongly acidic or alkaline medium.

This resistance can be increased further if through additional presence of silanol groups and/or alkoxy groups on the particle surface, in addition to the attachment of the particle to the organic matrix via formation of C—C bonds, it is possible for additional crosslinking to take place between the particles through M-O—Si—O—Si-M. Where alkoxysilyl functions and/or silanol functions are incorporated additionally into the polymer side chains through addition of free-radically polymerizable silanes, an additional postcrosslinking may also take place by formation of Si—O—Si bonds between particle and side chain or between side chain and side chain.

In addition to the dispersions of the invention, the jointing mortars of the invention also comprise further formulating constituents of the kind typically used for producing such preparations in the prior art, these being sand in any of a very wide variety of grain size fractions and compositions, water, optionally further binders as well; in addition, auxiliaries may be present:

Examples of auxiliaries are surfactants (C), with anionic surfactants, non-ionic surfactants, or cationic surfactants, or ampholytic surfactants being suitable.

Further auxiliaries are pigments (D), examples being earth pigments, such as chalk, ocher, umbra, green earth, mineral pigments, such as titanium dioxide, chromium yellow, red lead oxide, zinc yellow, zinc green, cadmium red, cobalt blue, organic pigments, such as sepia, Cassel brown, indigo, azo pigments, anthraquinonoid pigments, indigoid pigments, dioxazine pigments, quinacridone pigments, phthalocyanine pigments, isoindolinone pigments, and alkali blue pigments.

The jointing mortars may further comprise adjuvants (E). Adjuvants (E) are, for example, biocides, thickeners, alkyl orthotitanates, alkylboric esters, pigment-wetting agents and dispersants, antifoams, anticorrosion pigments, further metal oxides—not identical with the pigment (D) and not anticorrosion pigments—metal carbonates, and organic resins.

This recitation of the possible preparation constituents and auxiliaries is to be understood not as limiting but instead as exemplary, and is supplemented by the prior art.

The nanoparticle-containing organocopolymer dispersions of the invention are added in a suitable way during the operation of preparing the jointing mortar preparation, and combined homogeneously with the other preparation constituents, using the operations and procedures of the prior art therefor.

The jointing mortars contain preferably 1% to 90% by weight, more preferably 4% to 70% by weight, of the nanoparticle-containing organocopolymer dispersions.

The fractions in % by weight here are based in each case on the total weight of the building-material coating composition.

### EXAMPLES

### Example I

### Synthesis of Inventive Nanoparticle-Containing Copolymer Dispersions

(10% by weight particle 2, NMA (methyl methacrylate)/n-butyl acrylate 1/1):

Initial charge

| | | | | | |
|---|---|---|---|---|---|
| 16.6 | g | MMA | 16.6 | g | n-butyl acrylate |
| 92.4 | g | water | 1.8 | g | acrylic acid |
| 0.4 | g | sodium dodecyl sulfate | 0.16 | g | sodium vinylsulfonate |
| 10 | mg | each Fe(II) sulfate and | | | |
| | | EDTA | | | |

Feed 1a
10% solution of tert-butyl
hydroperoxide in H₂O
Feed 1b
5% solution of sodium
hydroxymethanesulfinate in H₂O
Feed 2

| | | | | | |
|---|---|---|---|---|---|
| 187.6 | g | water | 5.5 | g | acrylic acid |
| 13.3 | g | sodium dodecyl sulfate | 38.0 | g | particle 2 |
| 149.9 | g | n-butyl acrylate | 149.9 | g | MMA |

Solids content: 50.8%, pH: 8.1; Brookfield viscosity 48: 0.103 Pas; glass transition temperature T_{g}: 54° C.; (Nanosizer) Coulter: average particle size: 285 nm; PDI (polydispersity index): 1.2; surface area 22.43 m²/g; polymer filming: after drying through evaporation of water: streak- and tack-free film, no exudation of silicone. TEM micrographs: Si particle domains in the range 50-700 nm.

### Example 1

### Preparation of an Inventive Jointing Mortar

The following constituents are used, in the quantities stated:

625 g of copolymer dispersion from example I 1.67 g of SILFOAM® SD 860 antifoam, a colorless, turbid silicone antifoam based on aliphatic and naphthenic hydrocarbons with the addition of an organofunctional silicone and of hydrophobic fumed silica

1875 g of HR81T quartz sand, a quartz sand with a grain size of 0.16-0.60 mm.

The preparation is prepared in accordance with DIN EN 12808-2, 12808-3, and 12808-5:
place copolymer dispersion in a trough
add SILFOAM® SD 860 antifoam
add HR81T quartz sand
mix for 30 seconds
remove mixing paddle
scrape off paddle and trough within 1 minute
re-deploy paddle and mix for 1 minute

### Example 2

### Counter Example: Preparation of a Noninventive Jointing Mortar Preparation

The binder used for the comparative example was a commercially available binder for jointing mortars. This is the product ROMPOX®-D1. ROMPOX®-D1 is a pavement jointing mortar of low water-permeability, which causes virtually any incident amount of rainwater to run off on the surface. The emulsifiable pavement jointing mortar is ideally suitable for weed-free, abrasion- and sweeping machine-resistant, frost- and deicing salt-resistant, quick and permanent jointing of natural and concrete paving stones.

The product has the following properties:
self-compacting
water-emulsifiable
of low water-permeability after jointing
can be applied at ground temperatures>0° C.
for medium traffic loads, i.e., automobile and light truck traffic
two-component epoxy resin The comparison product is a two-component epoxy resin system (liquid/liquid). Accordingly, this product forms part of the group of synthetic-resin-base jointing mortars in which one component represents the resin itself and the other component represents the corresponding hardener.

The two-component ROMPOX®-D1 system consists, on the one hand, of the epoxy resin formulation, based on liquid bisphenol A resin and liquid bisphenol F resin, and on the other hand, the epoxy resin hardener is based on aliphatic polyamines. Both components possess a hazard potential on application and on disposal. The chemicals are classed as corrosive, irritant, harmful to the environment, and detrimental to health.

In the processing of the resin/hardener components, they are added slowly and above all completely, during the mixing operation, to the filler component, quartz sand or corundum, for example. In order to make this mixture fluid, a defined amount of water is added.

For preparing a jointing mortar preparation based on ROMPOX®-D1, the following amounts of the respective components are used:

125 g of ROMPOX®-D1 component A

125 g of ROMPOX®-D1 component B

2500 g of HR81T quartz sand, a quartz sand with a grain size of 0.16-0.60 mm

4 l of water.

The preparation is prepared in accordance with the instructions on the technical data sheet from the manufacturer of the ROMPOX®-D1 products. The filler component is introduced completely into a mixer. The mixer is started. During the mixing operation, components A and B as indicated above are added. After a mixing time of 3 minutes, 4 l of water are added, and mixing is continued for at least 3 minutes.

### Example 3

### Comparative Performance Tests

The inventive preparation from example 1, referred to below as “1”, and the noninventive comparative example 2, referred to below as “2”, are compared in terms of their performance properties.

### Production of the Test Specimens:

Test specimen for abrasion resistance and water absorption tests:

Use of a stencil as per DIN EN 12808-2

In deviation from DIN EN 12808-5, the test specimens for the water absorption test are produced using a silicone stencil which gives specimens with dimensions of 100×100×10 mm.

A sufficient amount of jointing mortar is applied over the stencil and then taken off cleanly so that the space in the stencil is completely filled.

In deviation from DIN EN 12808-2, when using 1 as binder, the stencil is not covered with a glass plate, since this significantly retards, if not indeed prevents, the evaporation of the water and hence the curing.

For the abrasion resistance and water absorption tests, 2 test specimens in each case are produced.

After 4 days of drying at room temperature, the specimen is stored in accordance with the stipulations of the standard.

### Test Specimens for Flexural and Compressive Strength:

The specimens are produced as per DIN EN 12808-3. In deviation from the DIN EN 12808-3 standard, the specimens are produced in a 10×40×160 mm silicone mold.

In deviation from DIN EN 12808-3, when using 1 as a binder, the stencil is not covered with a glass plate, since this significantly retards, if not indeed prevents, the evaporation of the water and hence the curing.

The test specimens are not compacted as described in DIN EN 12808-3, since the silicone mold cannot be adequately fastened on the shaker table.

### Testing of the Specimens:

### Water Absorption Test

After 21 days of storage under standard conditions, all side faces of the two respective identical test specimens of each jointing mortar preparation to be tested, except for one side face with dimensions of 100×10 mm, are sealed using Elastosil®N 2034, a very largely water-impermeable elastomer.

After 27 days of storage under standard conditions, the water absorption test is carried out to DIN EN 12808-5.

### Results:

For 1: first sample:

after 30 minutes: 0.06 g

after 240 minutes: 0.12 g

For 1: second sample:

b) after 30 minutes: 0.04 g

b) after 240 minutes: 0.08 g

Mean values for 1:

MV after 30 minutes: Wₘₜ=mₜ−m_{d}=0.05 g

MV after 240 minutes: Wₘₜ=mₜ−m_{d}=0.10 g

m_{d}=the mass of the dry specimen, in grams

mₜ=the mass of the specimen after immersion in water, in grams

For 2: first sample:

after 30 minutes 11.35 g;

after 240 minutes 12.17 g

For 2: second sample:

after 30 minutes 11.05 g;

after 240 minutes 11.86 g

Mean value for 2:

after 30 minutes: 11.20 g

after 240 minutes: 12.02 g

### Abrasion Resistance

After 27 days of storage in a controlled-climate chamber, the abrasion resistance is tested to DIN EN 12808-2.

### Results:

For 1:

29 mm+30 mm+28 mm+27 mm=114 mm/4=28.5 mm

28.5 mm=V=194 mm³ abrasion

For 2:

31 mm+29 mm+26 mm+29 mm=115 mm/4=28.75 mm;

2875 mm=199.5 mm³ abrasion

(see conversion table, DIN EN 12808-2)

### Flexural and Compressive Strength

After 27 days of storage in a controlled-climate chamber, the flexural and compressive strengths are tested to DIN EN 12808-3.

### Results:

For 1:

Flexural strength

| | | | |
|---|---|---|---|
| 4.24 | N/mm² | | |
| 4.04 | N/mm² | {close oversize brace} | MV = 4.10 N/mm² |
| 4.01 | N/mm² | | |

Compressive stength

| | | | |
|---|---|---|---|
| 6.13 | N/mm² | | |
| 10.73 | N/mm² | | |
| 9.98 | N/mm² | | |
| | | {close oversize brace} | MV = 9.68 N/mm² |
| 11.84 | N/mm² | | |
| 7.34 | N/mm² | | |
| 12.04 | N/mm² | | |

For 2:

Flexural strength

| | | | | |
|---|---|---|---|---|
| BDa | 3.37 | N/mm² | | |
| BDb | 3.27 | N/mm² | {close oversize brace} | MV = 3.24 N/mm² |
| BDc | 3.09 | N/mm² | | |

Compressive strength

| | | | | |
|---|---|---|---|---|
| BD | 6.87 | N/mm² | | |
| | 6.57 | N/mm² | | |
| | 6.03 | N/mm² | | |
| | | | {close oversize brace} | MV = 6.41 N/mm² |
| | 6.12 | N/mm² | | |
| | 6.53 | N/mm² | | |
| | 6.31 | N/mm² | | |

### Soiling Test:

The soilability is determined visually following application and subsequent removal, by washing, of the soiling source.

For this purpose, the respective jointing mortar is placed in a plastic ring (d=80 mm, h=5 mm), using the placement pattern shown in the Drawing. The tests are carried out following curing at room temperature for 4 days.

The soiling substances are applied to the substrate by pipette.

The behavior of the substrate drops is assessed at room temperature immediately after application and after 1, 5, and 24 hours.

### Evaluation

1 highly hydrophobic, no spreading

2 drop spreads

3 drop spreads, substrate easily absorbed drop

4 distinct spot, drop is fully absorbed by substrate

5 distinct spot on reverse face as well, drop seeps through substrate

In the case of ketchup and mustard, this assessment cannot be employed, since these substances possess a very high solids fraction and the drops are consequently unable to spread. Only the liquid from the substances is absorbed by the substrate.

| immediately after | | |
|---|---|---|
| application | 1 | 2 |
| A. ketchup | Drop stands on substrate, | Drop stands on substrate, |
| B. mustard | no absorption | no absorption |
| C. soy sauce | 2 | 4 |
| D. sunflower | 2 | 4 |
| oil 50° C. | | |
| E. used oil | 2 | 4 |
| F. ink | 2 | 4 |

| 1 hour after | | |
|---|---|---|
| application | 1 | 2 |
| A. ketchup | Drop stands on substrate, | Drop stands on substrate, |
| B. mustard | slight absorption | slight absorption |
| | of the liquid | of the liquid |
| C. soy sauce | 2 | 4 |
| D. sunflower | 2 | 5 |
| oil 50° C. | | |
| E. used oil | 3 | 5 |
| F. ink | 2 | 4 |

| 5 hours after | | |
|---|---|---|
| application | 1 | 2 |
| A. ketchup | Drop stands on substrate, | Drop stands on substrate, |
| B. mustard | slightly dried | slightly dried, liquid absorbed |
| C. soy sauce | 2 | 4 |
| D. sunflower | 2 | 5 |
| oil 50° C. | | |
| E. used oil | 3 | 5 |
| F. ink | 2 | 4 |

| 24 hours after | | |
|---|---|---|
| application | 1 | 2 |
| A. ketchup | Drop stands on substrate, | Drop stands on substrate, |
| B. mustard | dried up | dried up |
| C. soy sauce | 2 | 4 |
| D. sunflower | 2 | 5 |
| oil 50° C. | | |
| E. used oil | 3 | 5 |
| F. ink | 2 | 4 |

In the case of the specimens produced using 2, the blue ink used appears to have very largely disappeared, and not to have caused any soiling at all. There is merely a pale yellow spot remaining. This visual impression is evoked by a color change reaction under the influence of the pH. The blue ink dye is yellowish in the neutral to weakly basic range, but blue in the strongly basic range. 2 is strongly basic (pH=11), while 1 is approximately neutral (pH=7-8). Using an ink with a dye which is independent of the pH range in question, the result tabulated above is obtained.

After 24 hours, the specimens are washed off with a manual brush under running water.

On the jointing mortar with 2 as a binder, spots of all the substances are visible even after washing. These substances have penetrated the substrate and can no longer be removed. All of the substances can be washed off without residue from the specimen with 1 as a binder.

In an overall consideration of results, 1 is superior to 2 as a binder for jointing mortars. A further factor is that 1 does not have any health-detrimental effect, as is the case for 2. The application of 1 is much easier by comparison than that of 2, and can easily be accomplished even by an untrained, non-professional user. Completed mixtures of jointing mortars with 1 as a binder have a shelf life of months, provided suitable measures are taken to prevent evaporation of the water. Once the preparation has been produced in ready-to-use form, using the two-component binder 2, the curing time is equal to the storage time, and is therefore only a few hours. Excess preparation prepared using 2 must be discarded thereafter, and this may be an economic disadvantage to the user.

1. A process for preparing jointing mortar, which comprises using copolymers of ethylenically unsaturated monomers and of ethylenically functionalized nanoparticles in the form of their aqueous polymer dispersions or water-redispersible polymer powders, obtainable by means of free-radically initiated polymerization in aqueous medium, and optionally subsequent drying of the resultant polymer dispersion, of
A) one or more monomers from the group encompassing vinyl esters, (meth)acrylic esters, vinylaromatics, olefins, 1,3-dienes, vinyl ethers and vinyl halides, and optionally further monomers copolymerizable therewith, in the presence of
B) at least one particle P having an average diameter of ≦1000 nm and functionalized with ethylenically unsaturated, free-radically polymerizable groups, where
B1) one or more particles from the group of the metal oxides and semimetal oxides are used as particles P, and/or
B2) silicone resins are used as particles P, said resins being composed of repeating units of the general formula [R⁴_{(p+z)}SiO_{(4-p-z)/2}] (II) where R⁴ is identical or different at each occurrence and denotes hydrogen, hydroxyl, and also alkyl, cycloalkyl, aryl, alkoxy or aryloxy radicals, having in each case up to 18 C atoms, and being optionally substituted, with p+z being 0, 1 or 3 for at least 20 mol % of the respective silicone resin, and where B1) and B2) are each functionalized with one or more α-organosilanes of the general formula (R¹O)₃₋ₙ(R²)ₙSi—(CR³₂)—X (I), where R¹ is hydrogen, an alkyl radical having 1 to 6 carbon atoms or an aryl radical, R² and R³ each independently of one another are hydrogen, an alkyl radical having 1 to 12 carbon atoms or an aryl radical, n may be 0, 1 or 2, and X is a radical having 2 to 20 hydrocarbon atoms and an ethylenically unsaturated group.

2. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, the polymer dispersion or polymer powder further comprising up to 30% by weight, based on the total weight of components A) and B), of at least one silane of the general formula (R⁵)₄₋ₘ—Si—(OR⁶)ₘ (III), where m is a number 1, 2, 3 or 4, R⁵ is an organofunctional radical selected from the group alkoxy radical, aryloxy radical, phosphonic monoester radical, phosphonic diester radical, phosphonic acid radical, methacryloyloxy radical, acryloyloxy radical, vinyl radical, mercapto radical, isocyanato radical, it being possible for the isocyanato radical optionally to be reaction-blocked for protection from chemical reactions, hydroxyl radical, hydroxyalkyl radical, vinyl radical, epoxy radical, glycidyloxy radical, morpholino radical, piperazino radical, a primary, secondary or tertiary amino radical having one or more nitrogen atoms, it being possible for the nitrogen atoms to be substituted by hydrogen or by monovalent aromatic, aliphatic or cycloaliphatic hydrocarbon radicals, carboxylic acid radical, carboxylic anhydride radical, aldehyde radical, urethane radical, urea radical, it being possible for the radical R⁵ to be attached directly to the silicon atom or to be separated therefrom by a carbon chain of 1 to 6 C atoms, and R⁶ being a monovalent linear or branched aliphatic or cycloaliphatic hydrocarbon radical or a monovalent aromatic hydrocarbon radical or a radical —C(═O)—R⁷, where R⁷ is a monovalent linear or branched aliphatic or a cycloaliphatic hydrocarbon radical or a monovalent aromatic hydrocarbon radical.

3. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, use being made as comonomers A) of one or more monomers from the group vinyl acetate, vinyl esters of α-branched monocarboxylic acids having 9 to 11 C atoms, vinyl chloride, ethylene, methyl-acrylate, methyl methacrylate, ethyl acrylate, ethyl methacrylate, propyl acrylate, propyl methacrylate, n-butyl acrylate, n-butyl methacrylate, 2-ethylhexyl acrylate, styrene, 1,3-butadiene.

4. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, the α-organosilane of the formula (R¹O)₃₋ₙ(R²)ₙSi—(CR³₂)—X (I) comprising, as radicals R¹ and R², unsubstituted alkyl groups having 1 to 6 C atoms, and, as radical R³, hydrogen, and as radical X, monounsaturated C₂ to C₁₀ radicals.

5. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, use being made as particles P from the group B1) of silicon oxides and oxides of the metals aluminum, titanium, zirconium, tantalum, tungsten, hafnium, zinc, and tin.

6. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, use being made as silicon oxides of colloidal silica, fumed silica, precipitated silica, silica sols.

7. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, use being made as particles P from the group B2) of silicone resins of the general formula [R⁴_{(p+z)}SiO_{(4-p-z)/2}] which are composed to an extent of at least 30 mol % of Q units, and for which p+z has the definition 0.

8. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, use being made as particles P from the group B2) of silicone resins of the general formula [R⁴_{(p+z)}SiO_{(4-p-z)/2}] which are composed only of M and Q units, and for which p+z has the definition 0 and 3.

9. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, use being made as particles P from the group B2) of silicone resins of the general formula [R⁴_{(p+z)}SiO_{(4-p-z)/2}] which are composed of any desired combination of M units (R₃SiO—), D units (—OSiR₂O—), T units (RSiO₃³⁻) and Q units (SiO₄⁴⁻), with the proviso that there are always T and/or Q units present and that their fraction, as a proportion of the units which make up the silicone resin, is in total at least 20 mol %, and on initial introduction in each case of only one of these units, their proportion in each case is at least 20 mol %.

10. The process for preparing jointing mortar as claimed in claim 1, wherein copolymers of ethylenically unsaturated monomers and of ethylenically functionalized nanoparticles are used, in the form of their aqueous polymer dispersions or water-redispersible polymer powders, the average diameter of the particles P being 1 to 100 nm.

11. A jointing mortar which comprises copolymers of ethylenically unsaturated monomers and of ethylenically functionalized nanoparticles, in the form of their aqueous polymer dispersions or water-redispersible polymer powders, obtainable by means of free-radically initiated polymerization in aqueous medium, and optionally subsequent drying of the resultant polymer dispersion, of
A) one or more monomers from the group encompassing vinyl esters, (meth)acrylic esters, vinylaromatics, olefins, 1,3-dienes, vinyl ethers, and vinyl halides, and optionally further monomers copolymerizable therewith, in the presence of
B) at least one particle P having an average diameter of ≦1000 nm and functionalized with ethylenically unsaturated, free-radically polymerizable groups, where
B1) one or more particles from the group of the metal oxides and semimetal oxides are used as particles P, and/or
B2) silicone resins are used as particles P, said resins being composed of repeating units of the general formula [R⁴_{(p+z)}SiO_{(4-p-z)/2}] (II) where R⁴ is identical or different at each occurrence and denotes hydrogen, hydroxyl, and also alkyl, cycloalkyl, aryl, alkoxy or aryloxy radicals, having in each case up to 18 C atoms, and being optionally substituted, with p+z being 0, 1 or 3 for at least 20 mol % of the respective silicone resin, and where B1) and B2) are each functionalized with one or more α-organosilanes of the general formula (R¹O)₃₋ₙ(R²)ₙSi—(CR³₂)—X (I), where R¹ is hydrogen, an alkyl radical having 1 to 6 carbon atoms or an aryl radical, R² and R³ each independently of one another are hydrogen, an alkyl radical having 1 to 12 carbon atoms or an aryl radical, n may be 0, 1 or 2, and X is a radical having 2 to 20 hydrocarbon atoms and an ethylenically unsaturated group.

12. The jointing mortar as claimed in claim 11, wherein copolymers of ethylenically unsaturated monomers and of ethylenically functionalized nanoparticles are used, in the form of their aqueous polymer dispersions or water-redispersible polymer powders, the polymer dispersion or polymer powder further comprising up to 30% by weight, based on the total weight of components A) and B), of at least one silane of the general formula (R⁵)₄₋ₘ—Si—(OR⁶)ₘ (III), where m is a number 1, 2, 3 or 4, R⁵ is an organofunctional radical selected from the group alkoxy radical, aryloxy radical, phosphonic monoester radical, phosphonic diester radical, phosphonic acid radical, methacryloyloxy radical, acryloyloxy radical, vinyl radical, mercapto radical, isocyanato radical, it being possible for the isocyanato radical optionally to be reaction-blocked for protection from chemical reactions, hydroxyl radical, hydroxyalkyl radical, vinyl radical, epoxy radical, glycidyloxy radical, morpholino radical, piperazino radical, a primary, secondary or tertiary amino radical having one or more nitrogen atoms, it being possible for the nitrogen atoms to be substituted by hydrogen or by monovalent aromatic, aliphatic or cycloaliphatic hydrocarbon radicals, carboxylic acid radical, carboxylic anhydride radical, aldehyde radical, urethane radical, urea radical, it being possible for the radical R⁵ to be attached directly to the silicon atom or to be separated therefrom by a carbon chain of 1 to 6 C atoms, and R⁶ being a monovalent linear or branched aliphatic or cycloaliphatic hydrocarbon radical or a monovalent aromatic hydrocarbon radical or a radical —C(═O)—R⁷, where R⁷ is a monovalent linear or branched aliphatic or a cycloaliphatic hydrocarbon radical or a monovalent aromatic hydrocarbon radical.

13. The jointing mortar as claimed in claim 11, wherein copolymers of ethylenically unsaturated monomers and of ethylenically functionalized nanoparticles are present, in the form of their aqueous polymer dispersions or water-redispersible polymer powders, use being made as comonomers A) of one or more monomers from the group vinyl acetate, vinyl esters of α-branched monocarboxylic acids having 9 to 11 C atoms, vinyl chloride, ethylene, methyl acrylate, methyl methacrylate, ethyl acrylate, ethyl methacrylate, propyl acrylate, propyl methacrylate, n-butyl acrylate, n-butyl meth-acrylate, 2-ethylhexyl acrylate, styrene, 1,3-butadiene.

14. The jointing mortar as claimed in claim 11, wherein copolymers of ethylenically unsaturated monomers and of ethylenically functionalized nanoparticles are present, in the form of their aqueous polymer dispersions or water-redispersible polymer powders, the α-organosilane of the formula (R¹O)₃₋ₙ(R²)ₙSi—(CR³₂)—X (I) comprising, as radicals R¹ and R², unsubstituted alkyl groups having 1 to 6 C atoms, and, as radical R³, hydrogen, and as radical X, monounsaturated C₂ to C₁₀ radicals.

15. The jointing mortar as claimed in claim 11, wherein copolymers of ethylenically unsaturated monomers and of ethylenically functionalized nanoparticles are present, in the form of their aqueous polymer dispersions or water-redispersible polymer powders, use being made as particles P from the group B1) of silicon oxides and oxides of the metals aluminum, titanium, zirconium, tantalum, tungsten, hafnium, zinc, and tin.

16. The jointing mortar as claimed in claim 11, wherein copolymers of ethylenically unsaturated monomers and of ethylenically functionalized nanoparticles are present, in the form of their aqueous polymer dispersions or water-redispersible polymer powders, use being made as silicon oxides of colloidal silica, fumed silica, precipitated silica, silica sols.

17. The jointing mortar as claimed in claim 11, wherein copolymers of ethylenically unsaturated monomers and of ethylenically functionalized nanoparticles are present, in the form of their aqueous polymer dispersions or water-redispersible polymer powders, use being made as particles P from the group B2) of silicone resins of the general formula [R⁴_{(p+z)}SiO_{(4-p-z)/2}] which are composed to an extent of at least 30 mol % of Q units, and for which p+z has the definition 0.

18. The jointing mortar as claimed in claim 11, wherein copolymers of ethylenically unsaturated monomers and of ethylenically functionalized nanoparticles are present, in the form of their aqueous polymer dispersions or water-redispersible polymer powders, use being made as particles P from the group B2) of silicone resins of the general formula [R⁴_{(p+z)}SiO_{(4-p-z)/2}] which are composed only of M and Q units, and for which p+z has the definition 0 and 3.

19. The jointing mortar as claimed in claim 11, wherein copolymers of ethylenically unsaturated monomers and of ethylenically functionalized nanoparticles are present, in the form of their aqueous polymer dispersions or water-redispersible polymer powders, use being made as particles P from the group B2) of silicone resins of the general formula [R⁴_{(p+z)}SiO_{(4-p-z)/2}] which are composed of any desired combination of M units (R₃SiO—), D units (—OSiR₂O—), T units (RSiO₃³⁻) and Q units (SiO₄⁴⁻), with the proviso that there are always T and/or Q units present and that their fraction, as a proportion of the units which make up the silicone resin, is in total at least 20 mol %, and on initial introduction in each case of only one of these units, their proportion in each case is at least 20 mol %.

20. The jointing mortar as claimed in claim 11, wherein copolymers of ethylenically unsaturated monomers and of ethylenically functionalized nanoparticles are present, in the form of their aqueous polymer dispersions or water-redispersible polymer powders, the average diameter of the particles P being 1 to 100 nm.
